(19) United States
(12) Patent Application Publication
(10) Pub. No.: US 2020/0158161 A1
(43) Pub. Date: May 21, 2020

(54) Self-Sealing Collar for Straight Shank Fasteners

(71) Applicant: The Boeing Company, Chicago, IL (US)

(72) Inventors: Sean D. Morden, Federal Way, WA (US); Michael P. Corcoran, Snohomish, WA (US)

(21) Appl. No.: 16/280,590

(22) Filed: Feb. 20, 2019

Related U.S. Application Data
(60) Provisional application No. 62/769,943, filed on Nov. 20, 2018.

(51) Int. Cl. F16B 43/00; F16B 31/02

(52) U.S. Cl. CPC F16B 43/001; B64D 37/06; F16B 31/021

(57) ABSTRACT

A collar for use with a straight shank bolt includes a body having a first end and a second end opposite the first end. The collar further includes an interior threaded portion formed within the body and a seal cavity formed within the body. The seal cavity is positioned adjacent to the interior threaded portion, between the interior threaded portion and the second end. The collar further comprises a resilient seal positioned within the seal cavity, where the resilient seal is deformable under pressure to form a seal at the second end of the collar, around a circumference of the straight shank bolt.

### CROSS REFERENCE TO RELATED APPLICATION

The present disclosure claims priority to U.S. application No. 62/769,943, filed on Nov. 20, 2018, the entire contents of which are herein incorporated by reference.

### FIELD

The present disclosure generally relates to self-sealing fasteners and methods of sealing a bolt hole formed in a part, such as an aircraft part that requires a fluid-tight seal.

### BACKGROUND

Current fasteners for sealing bolt holes in an aircraft application that requires a fluid-tight seal have focused on fasteners and seals that may not be able to provide the required seal pressure on their own. For example, existing fasteners used to seal a fuel tank of an aircraft require the use of additional fuel tank sealant and cap seals that are placed over the already-installed fasteners in order to meet tightness requirements. These require additional assembly steps, which translates into labor time and cost, which can be significant when multiplied by the total number of fasteners that must be installed.

There is a need for improved self-sealing fasteners and methods for sealing a bolt hole formed in a part.

### SUMMARY

A collar for use with a straight shank bolt is described. The collar includes a body having a first end and a second end opposite the first end. The collar further includes an interior threaded portion formed within the body and a seal cavity formed within the body. The seal cavity is positioned adjacent to the interior threaded portion, between the interior threaded portion and the second end. The collar further comprises a resilient seal positioned within the seal cavity, where the resilient seal is deformable under pressure to form a seal at the second end of the collar, around a circumference of the straight shank bolt.

In another example, a system for sealing a bolt hole formed in a part is described. The system includes a straight shank bolt extending from the bolt hole, where the straight shank bolt includes a threaded shaft. The system further includes a collar fastened to the straight shank bolt, the collar including a body having a first end and a second end opposite the first end. The collar also includes an interior threaded portion formed within the body, a seal cavity formed within the body, the seal cavity positioned adjacent to the interior threaded portion, between the interior threaded portion and the second end, and a resilient seal positioned within the seal cavity, where the resilient seal is deformable under pressure to form a seal at the second end of the collar, around a circumference of the straight shank bolt.

In another example, a method of fabricating sealing a bolt hole formed in a part is described, where a straight shank bolt having a threaded shaft extends from the bolt hole. The method includes positioning a collar on the straight shank bolt, the collar including a body having a first end and a second end opposite the first end. The collar also includes an interior threaded portion formed within the body, a seal cavity formed within the body, the seal cavity positioned adjacent to the interior threaded portion, between the interior threaded portion and the second end, and a resilient seal positioned within the seal cavity. The method further includes fastening the interior threaded portion of the collar onto the threaded shaft of the straight shank bolt such that the second end of the collar is positioned adjacent to the part and surrounding the bolt hole, and where the resilient seal deforms under pressure to form a seal around a circumference of the straight shank bolt.

The features, functions, and advantages that have been discussed can be achieved independently in various examples or may be combined in yet other examples, further details of which can be seen with reference to the following description and drawings.

### BRIEF DESCRIPTION OF THE FIGURES

The novel features believed characteristic of the illustrative examples are set forth in the appended claims. The illustrative examples, however, as well as a preferred mode of use, further objectives and descriptions thereof, will best be understood by reference to the following detailed description of an illustrative example of the present disclosure when read in conjunction with the accompanying Figures. The Figures are not to scale.

FIG. 1 illustrates a cross-sectional side view of a collar for use with a straight shank bolt, according to an example implementation.

FIG. 2 illustrates a cross-sectional perspective view of a collar for use with a straight shank bolt, according to an example implementation.

FIG. 3 illustrates a cross-sectional perspective view of a collar for use with a straight shank bolt, according to an example implementation.

FIG. 4 illustrates a side view of a collar for use with a straight shank bolt, according to an example implementation.

FIG. 5 illustrates a perspective view of a collar for use with a straight shank bolt, according to an example implementation.

FIG. 6 illustrates a perspective view of a collar for use with a straight shank bolt, according to an example implementation.

FIG. 7 illustrates an unassembled, cross-sectional side view of a system for sealing a bolt hole formed in a part.

FIG. 8 illustrates an assembled, cross-sectional side view of a system for sealing a bolt hole formed in a part.

FIG. 9 shows a flowchart of an example method of sealing a bolt hole formed in a part, according to an example implementation.

### DETAILED DESCRIPTION

Disclosed examples will now be described more fully with reference to the accompanying Figures, in which some, but not all of the disclosed examples are shown. Indeed, several different examples may be described and should not be construed as limited to the examples set forth herein. Rather, these examples are described so that this disclosure will be thorough and complete and will fully convey the scope of the disclosure to those skilled in the art.

Examples discussed herein include self-sealing fasteners and methods of sealing a bolt hole formed in a part, such as an aircraft part. In some examples, a collar for use with a straight shank bolt may include a resilient seal and body that houses a seal cavity. The collar may be formed from relatively high strength materials that, although heavier than some existing fasteners, allow the collar and included resilient seal to meet fluid tightness requirements without the need for additional caps and sealants. The collar may also include a frangible region that is radially separated from an interior threaded portion of the collar. This may reduce the likelihood that an intended shear breakage that occurs upon fastening the collar might affect the interior threaded portion of the collar.

By the term “about” or “substantial” and “substantially” or “approximately,” with reference to amounts or measurement values, it is meant that the recited characteristic, parameter, or value need not be achieved exactly. Rather, deviations or variations, including, for example, tolerances, measurement error, measurement accuracy limitations, and other factors known to those skilled in the art, may occur in amounts that do not preclude the effect that the characteristic was intended to provide.

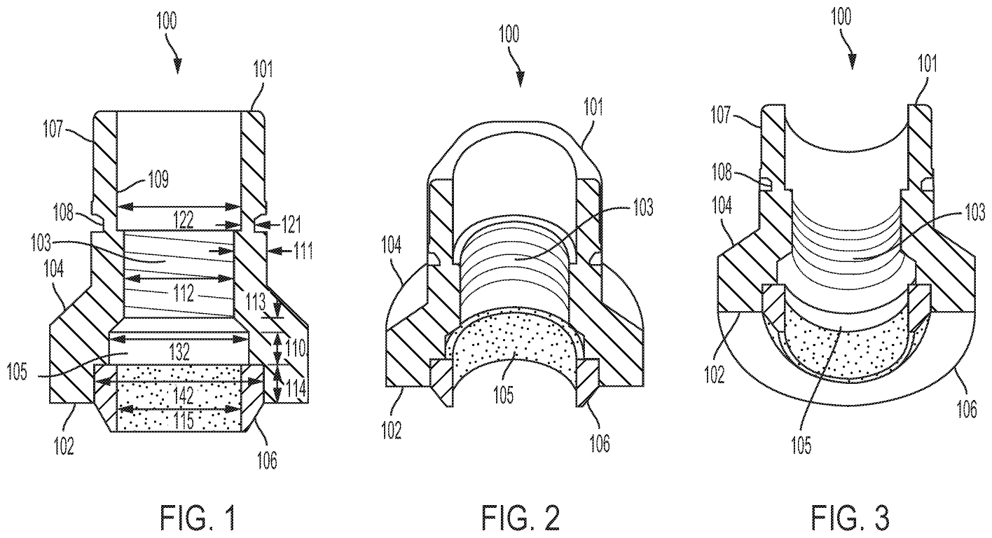

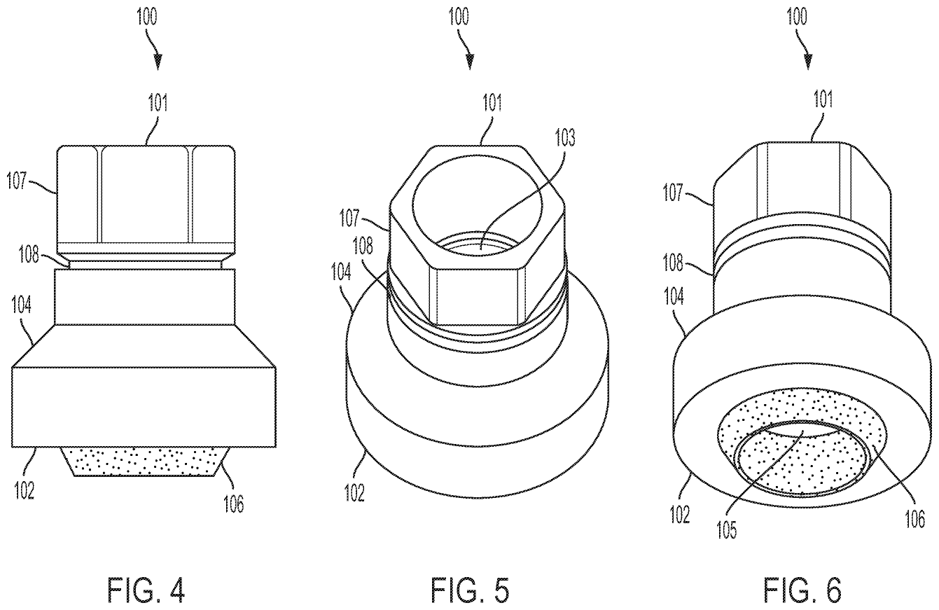

Referring now to FIG. 1, a cross-sectional side view of a collar 100 is shown, according to an example implementation. The collar 100 may be used, for instance, as a self-sealing fastener in conjunction with a straight shank bolt. FIGS. 2 and 3 depict additional cross-sectional, perspective views of the collar 100. Similarly, FIGS. 4, 5, and 6 show non-cross-sectional side and perspective views of the collar 100 corresponding to FIGS. 1, 2, and 3, respectively.

Returning to FIG. 1, the collar 100 includes a body 104 having a first end 101, shown as the top end in the examples discussed herein. The body 104 of the collar 100 further includes a second end 102 opposite the first end 101, and an interior threaded portion 103 formed within the body 104. The collar 100 also includes a seal cavity 105 formed within the body 104. The seal cavity 105 is positioned adjacent to the interior threaded portion 103, between the interior threaded portion 103 and the second end 102.

The collar 100 shown in FIG. 1 also includes a resilient seal 106 positioned within the seal cavity 105. The resilient seal 106 is deformable under pressure to form a seal at the second end 102 of the collar 100, around a circumference of the straight shank bolt. For example, as shown in FIG. 1, the resilient seal 106 protrudes beyond the second end 102 of the body 104. Thus, when the collar 100 is fastened onto a straight shank bolt such that the second end 102 is flush with an adjacent part, the resilient seal 106 will deform under pressure and flow upward into the seal cavity 105 of the body 104, surrounding the straight shank bolt.

In some implementations as otherwise discussed herein, the resilient seal 106 may be a teflon seal. Other resilient materials are also possible, including polymers such as rubber or PEEK. In some other implementations, the resilient seal 106 may be formed from a material that undergoes plastic deformations within the seal cavity 105, such that its shape is permanently changed upon fastening of the collar 100. Other examples are also possible, including a seal formed from a combination of two or more different materials.

As discussed above, the resilient seal 106 is deformable under pressure. In some cases, the resilient seal 106 may be formed from a material that is also relatively incompressible. Therefore, the resilient seal 106 may be sized in order to fill the void that will exist between the straight shank bolt and the seal cavity 105. For example, the seal cavity 105 may have a first volume surrounding the circumference of the straight shank bolt, and the resilient seal 106 may have a second volume that is substantially equal to the first volume.

As shown in FIGS. 1-6, the collar 100 also includes a torque-transmitting shaft 107 positioned between the interior threaded portion 103 and the first end 101. For example, the torque-transmitting shaft 107 may be hex-shaped to facilitate fastening the collar 100 onto a straight shank bolt with a socket driver or other fastening tool. Other configurations of the torque-transmitting shaft 107 are also possible.

In some implementations, the collar 100 includes a frangible region 108 where the torque-transmitting shaft 107 is configured to shear apart from the collar 100 under a predetermined torque. For example, as shown in FIG. 1, the interior threaded portion 103 of the collar 100 includes a first wall thickness 111, whereas the frangible region 108 of the collar 100 has a second wall thickness 121 that is less than the first wall thickness 111. The second wall thickness 121 may be selected based on a designed maximum torque. Thus, once the collar 100 is fastened to the predetermined tightness, the torque-transmitting shaft 107 breaks away. The collar 100 is then permanently in place, short of more destructive removal methods.

In some examples, it may be desirable to reduce the likelihood that the shearing of the collar 100 at the frangible region 108 might affect the integrity of the interior threaded portion 103. For example, as shown in FIG. 1, the interior threaded portion 103 includes a first diameter 112, and the frangible region 108 of the collar 100 includes an inner surface 109 having a second diameter 122 that is greater than the first diameter 112 of the interior threaded portion 103. This difference in diameter between the interior threaded portion 103 and the inner surface 109 of the frangible region 108 introduces a step in the interior profile of the collar 100. As a result, the location that the torque-transmitting shaft 107 shears away from the collar 100 is moved radially outward—and out of plane—from the inside wall of the interior threaded portion 103. This reduces the possibility that the shearing of the collar 100 might cause cracks or other instabilities to propagate downward into the interior threaded portion 103.

Although this additional step within the collar 100 may introduce greater complexity to the fabrication of the collar 100, the decreased probability of failure may be worthwhile, especially where the collar 100 is intended by provide a fluid seal around a straight shank bolt. For example, the collar 100 may be fastened to a straight shank bolt to seal a fuel tank of an aircraft.

As discussed above, the interior threaded portion 103 of the collar 100 may have a first diameter 112. Adjacent to the interior threaded portion 103, the seal cavity 105 may include a counterbore region 110 having a third diameter 132 that is greater than the first diameter 112, as seen in FIG. 1. The seal cavity 105 also includes a transition region 113 between the counterbore region 110 and the interior threaded portion 103.

As can be seen in FIG. 1, the transition region 113 of the seal cavity 105 is not a smooth or gradual transition. In cross-section, the transition region 113 includes a straight line from where it connects the interior threaded portion 103 and the counterbore region 110, which are parallel. The transition region 113 lacks a radius at either location, resulting in a relatively sharp interior profile of the seal cavity 105.

These sharp transitions of the collar 100 within the seal cavity 105 provide a bearing surface that is capable of applying and maintaining the necessary pressure around the straight shank bolt, via the resilient seal 106, to meet fluid tightness requirements without the use of additional sealants. This configuration of the collar 100 is made possible by using relatively high strength materials. For instance, the body 104 may be formed from a material having a yield strength within a range of 140,000 psi to 260,000 psi.

Conversely, existing fasteners used in liquid sealing applications on an aircraft have generally been formed from lower strength, lighter materials, because the prevailing wisdom has been to minimize the weight of assembly components for flight as much as possible. These existing fasteners cannot maintain the same interior profile as the collar 100, and therefore usually cannot meet fluid tightness requirements by themselves, resulting in the need for additional caps, sealants, and the like. Even with the additional sealing components, many are still lighter than the collar 100. Nonetheless, it may be desirable in some applications to forego the benefits of reduced weight in order decrease the assembly time of a given aircraft.

The seal cavity 105 also includes a seal seating region 114 positioned adjacent to the second end 102. The seal seating region 114 has a fourth diameter 142 that is greater than the third diameter 132 of the counterbore region 110. As shown in FIG. 1, the resilient seal 106 is positioned within the seal cavity 105 via an interference fit with the seal seating region 114. This may allow the collar 100 to be distributed and utilized as a unitary component, with the resilient seal 106 already in place. Additionally or alternatively, a small amount of adhesive, such as a teflon glue, may be used to hold the resilient seal 106 in place within the seal seating region 114 before use of the collar 100. Additionally, the seal seating region 114 shown in FIG. 1 also includes sharp, 90 degree directional transitions from the counterbore region 110, consistent with the discussion of the seal cavity 105 above.

In some implementations as otherwise discussed herein, the resilient seal 106 includes an inner diameter 115 that is greater than the first diameter 112 of the interior threaded portion 103. This may provide some clearance between the resilient seal 106 and the straight shank bolt when the collar 100 is initially positioned on the straight shank bolt, which may reduce the likelihood that the resilient seal 106 is damaged or dislodged during installation of the collar 100.

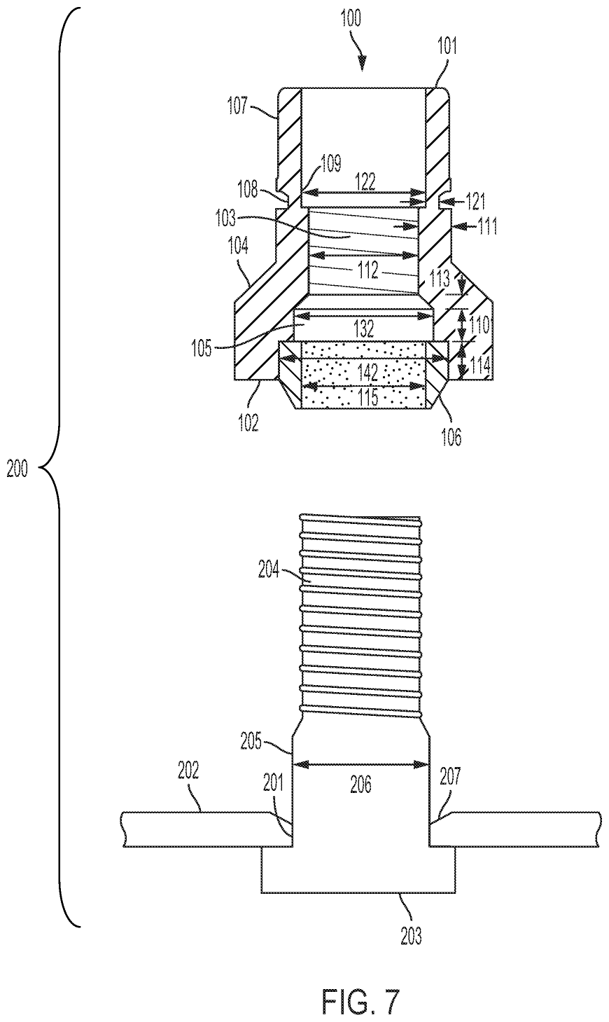

Turning now to FIG. 7, an unassembled, cross-sectional side view of a system 200 is shown for sealing a bolt hole 201 formed in a part 202. As mentioned above, the part 202 may be the wall of a fuel tank on an aircraft, for example. As shown in FIG. 7, a straight shank bolt 203 may be inserted through the bolt hole 201 such that the straight shank bolt 203 extends from the bolt hole 201. The straight shank bolt 203 includes a threaded shaft 204 and a shank portion 205, which is threadless.

The system 200 also includes a collar, such as the collar 100 shown in FIGS. 1-6 and discussed above. For example, the body 104 includes a first end 101 and a second end 102 opposite the first end 101, as well as an interior threaded portion 103 formed within the body 104. A seal cavity 105 formed within the body 104, and is positioned adjacent to the interior threaded portion 103, between the interior threaded portion 103 and the second end 102.

The collar 100 also includes a resilient seal 106 positioned within the seal cavity 105. As noted previously, the resilient seal 106 is deformable under pressure to form a seal at the second end 102 of the collar 100, around a circumference of the straight shank bolt 203. The resilient seal 106 may be, for example, a teflon seal, or it may take a number of other forms, as discussed above.

As shown in FIG. 7, the collar 100 may include a torque-transmitting shaft 107 to facilitate fastening the collar 100 onto the straight shank bolt 203. Further, the interior threaded portion 103 includes a first diameter 112. The collar 100 may include a frangible region 108 having an inner surface 109 with a second diameter 122 that is greater than the first diameter 112 of the interior threaded portion 103. As discussed above, this arrangement may reduce the likelihood that the breaking away of the torque-transmitting shaft 107 upon fastening affects the interior threaded portion 103.

Further, the seal cavity 105 includes a counterbore region 110 having a third diameter 132 that is greater than the first diameter 112 of the interior threaded portion 103. The seal cavity 105 also includes a transition region 113 positioned between the counterbore region 110 and the interior threaded portion 103, and a seal seating region 114 positioned adjacent to the second end 102. The seal seating region 114 includes a fourth diameter 142 that is greater than the third diameter 132.

As discussed above, the interior profile of the seal cavity 105 includes relatively sharp changes in direction, which provides for increased bearing strength that can, in conjunction with the resilient seal 106, result in a seal that meets fluid tightness requirements without the need for additional sealing components. As mentioned above, this configuration of the seal cavity 105 is made possible at least in part through the use of relatively a high strength material for the collar 100. For instance, the body 104 may be formed from a material having a yield strength within a range of 140,000 psi to 260,000 psi.

In some examples, the resilient seal 106 includes an inner diameter 115 that is greater than the first diameter 112 of the interior threaded portion 103. Further, the shank portion 205 of the straight shank bolt 203 may have a shank diameter 206 that is greater than the first diameter 112 of the interior threaded portion 103, but less than the inner diameter 115 of the resilient seal 106. This may provide some clearance between the resilient seal 106 and the straight shank bolt 203 when the collar 100 is initially positioned on the straight shank bolt 203. This may reduce the likelihood that the resilient seal 106 is damaged or dislodged during installation of the collar 100.

As noted above, the seal cavity 105 may have a first volume surrounding the circumference of the straight shank bolt 203, and the resilient seal 106 may include a second volume, where the first volume is substantially equal to the second volume. In some implementations as otherwise discussed herein, the bolt hole 201 may include a countersunk surface 207, as shown in FIG. 7, and the resilient seal 106 may further seal the countersunk surface 207 of the bolt hole 201. In such an implementation, the countersunk surface 207 of the bolt hole 201 includes a third volume, and the resilient seal 106 may be sized such that the second volume of the resilient seal 106 is substantially equal to the first volume of the seal cavity 105 plus the third volume of the countersunk surface 207.

Within examples, an outer diameter of the countersunk surface 207 is smaller than a diameter of the fourth diameter 142 of the seal seating region 114 of the resilient seal 106 to cause a tight seal to form.

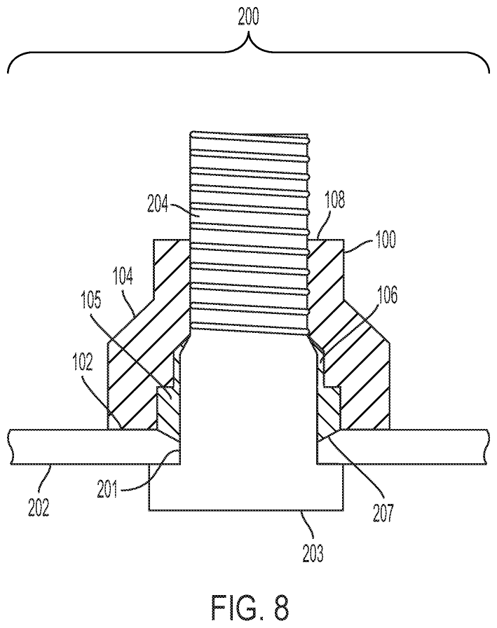

For example, FIG. 8 shows an assembled, cross-sectional side view of the system 200, where the collar 100 is fastened to the straight shank bolt 203 and the torque-transmitting shaft 107 has sheared away from the collar 100 at the frangible region 108, as discussed above. Further, the resilient seal 106 has deformed upward, further into the seal cavity 105, under the pressure of fastening the collar 100 against the part 202. Thus, as shown in FIG. 8, the resilient seal 106 fills both the countersunk surface 207 of the bolt hole 201 and the seal cavity 105 around the circumference of the straight shank bolt 203.

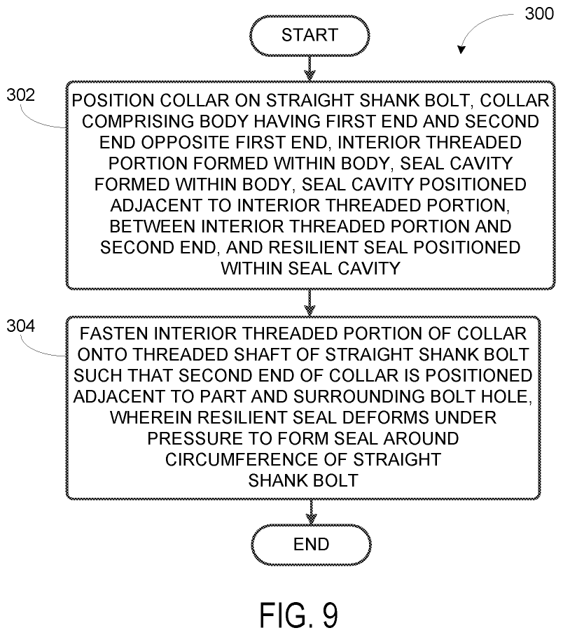

Turning now to FIG. 9, a flowchart of a method 300 of sealing a bolt hole formed in a part is shown, according to an example implementation. Method 300 shown in FIG. 9 presents an example of a method that, for instance, could be used with the collar 100 and the system 200, as shown in FIGS. 1-8 and discussed herein. It should be understood that for these and other processes and methods disclosed herein, flowcharts show functionality and operation of one possible implementation of present examples. In this regard, each block in a flowchart may represent a module, a segment, or a portion of program code, which includes one or more instructions executable by a processor for implementing or causing specific logical functions or steps in the process. For example, the method 300 may be implemented in whole or in part by one or more computing devices of a robotic assembly system. Alternative implementations are included within the scope of the examples of the present disclosure, in which functions may be executed out of order from that shown or discussed, including substantially concurrently, depending on the functionality involved, as would be understood by those reasonably skilled in the art.

The method 300 involves sealing a bolt hole 201 formed in a part 202, where a straight shank bolt 203 having a threaded shaft 204 extends from the bolt hole 201, as shown in FIGS. 7 and 8.

At block 302, the method 300 includes positioning a collar, such as the collar 100 discussed herein, on the straight shank bolt 203. The collar 100 includes a body 104 having a first end 101 and a second end 102 opposite the first end 101, as well as an interior threaded portion 103 formed within the body 104.

The collar 100 further includes a seal cavity 105 formed within the body 104, and seal cavity 105 positioned adjacent to the interior threaded portion 103, between the interior threaded portion 103 and the second end 102. A resilient seal 106 is positioned within the seal cavity 105, as shown in FIGS. 1-7. Further, the collar 100 may include some or all of the configurations and attributes discussed above with respect to FIGS. 1-6, and the system 200 discussed in FIGS. 7 and 8.

At block 304, the method 300 includes fastening the interior threaded portion 103 of the collar 100 onto the threaded shaft 204 of the straight shank bolt 203 such that the second end 102 of the collar 100 is positioned adjacent to the part 202 and surrounding the bolt hole 201. This arrangement can be seen in FIG. 8, as discussed above. The resilient seal 106 deforms under pressure to form a seal around a circumference of the straight shank bolt 203.

Further, fastening the interior threaded portion 103 of the collar 100 onto the threaded shaft 204 of the straight shank bolt 203 includes deforming the resilient seal 106 to substantially fill the seal cavity 105. This can been seen in FIG. 8, where the resilient seal 106 has been deformed from its initial shape shown in FIG. 7 to fill the volume of the seal cavity 105 surrounding the straight shank bolt 203.

In some implementations, the collar 100 includes a torque-transmitting shaft 107 having a frangible region 108 positioned between the interior threaded portion 103 and the first end 101. As shown in FIG. 7, the frangible region 108 includes an inner surface 109 having a second diameter 122 that is greater than the first diameter 112 of the interior threaded portion 103. In such an implementation, and as discussed above, fastening the interior threaded portion 103 of the collar 100 onto the threaded shaft 204 of the straight shank bolt 203 may include fastening until the torque-transmitting shaft 107 shears apart from the collar 100. This may occur when a predetermined torque threshold is reached.

As shown in FIGS. 7 and 8, the bolt hole 201 in some implementations may include a countersunk surface 207. In these situations, fastening the interior threaded portion 103 of the collar 100 onto the threaded shaft 204 of the straight shank bolt 203 may further include deforming the resilient seal 106 to seal the countersunk surface 207 of the bolt hole 201, as shown in the assembled view of FIG. 8.

The description of the different advantageous arrangements has been presented for purposes of illustration and description, and is not intended to be exhaustive or limited to the examples in the form disclosed. Many modifications and variations will be apparent to those of ordinary skill in the art. Further, different advantageous examples may describe different advantages as compared to other advantageous examples. The example or examples selected are chosen and described in order to explain the principles of the examples, the practical application, and to enable others of ordinary skill in the art to understand the disclosure for various examples with various modifications as are suited to the particular use contemplated.

What is claimed is:

1. A collar for use with a straight shank bolt, the collar comprising:
a body having a first end and a second end opposite the first end;
an interior threaded portion formed within the body;
a seal cavity formed within the body, the seal cavity positioned adjacent to the interior threaded portion, between the interior threaded portion and the second end; and
a resilient seal positioned within the seal cavity, wherein the resilient seal is deformable under pressure to form a seal at the second end of the collar, around a circumference of the straight shank bolt.

2. The collar of claim 1, further comprising:
a torque-transmitting shaft positioned between the interior threaded portion and the first end, wherein the collar comprises a frangible region where the torque-transmitting shaft is configured to shear apart from the collar under a predetermined torque.

3. The collar of claim 2, wherein the interior threaded portion of the collar comprises a first wall thickness, and wherein the frangible region of the collar comprises a second wall thickness that is less than the first wall thickness.

4. The collar of claim 2, wherein interior threaded portion comprises a first diameter, and wherein the frangible region of the collar comprises an inner surface having a second diameter that is greater than the first diameter of the interior threaded portion.

5. The collar of claim 1, wherein the seal cavity has a first volume surrounding the circumference of the straight shank bolt and the resilient seal has a second volume, the first volume being substantially equal to the second volume.

6. The collar of claim 1, wherein the interior threaded portion comprises a first diameter, and wherein the seal cavity comprises:
a counterbore region having a third diameter that is greater than the first diameter;
a transition region between the counterbore region and the interior threaded portion; and
a seal seating region positioned adjacent to the second end, wherein the seal seating region comprises a fourth diameter that is greater than the third diameter, and wherein the resilient seal is positioned within the seal cavity via an interference fit with the seal seating region.

7. The collar of claim 1, wherein the interior threaded portion comprises a first diameter, and wherein the resilient seal comprises an inner diameter that is greater than the first diameter.

8. The collar of claim 1, wherein the body is formed from a material having a yield strength within a range of 140,000 psi to 260,000 psi.

9. The collar of claim 1, wherein the resilient seal comprises a teflon seal.

10. A system for sealing a bolt hole formed in a part, the system comprising:
a straight shank bolt extending from the bolt hole, wherein the straight shank bolt comprises a threaded shaft; and
a collar fastened to the straight shank bolt, the collar comprising:
a body having a first end and a second end opposite the first end;
an interior threaded portion formed within the body;
a seal cavity formed within the body, the seal cavity positioned adjacent to the interior threaded portion, between the interior threaded portion and the second end; and
a resilient seal positioned within the seal cavity, wherein the resilient seal is deformable under pressure to form a seal at the second end of the collar, around a circumference of the straight shank bolt.

11. The system of claim 10, wherein interior threaded portion comprises a first diameter, and wherein the collar comprises a frangible region having an inner surface comprising a second diameter that is greater than the first diameter of the interior threaded portion.

12. The system of claim 10, wherein the seal cavity has a first volume surrounding the circumference of the straight shank bolt and the resilient seal has a second volume, the first volume being substantially equal to the second volume.

13. The system of claim 10, wherein the interior threaded portion comprises a first diameter, and wherein the seal cavity comprises:
a counterbore region having a third diameter that is greater than the first diameter;
a transition region positioned between the counterbore region and the interior threaded portion; and
a seal seating region positioned adjacent to the second end, wherein the seal seating region comprises a fourth diameter that is greater than the third diameter.

14. The system of claim 10, wherein the bolt hole comprises a countersunk surface, and wherein the resilient seal seals the countersunk surface of the bolt hole.

15. The system of claim 10, wherein the body is formed from a material having a yield strength within a range of 140,000 psi to 260,000 psi.

16. The system of claim 10, wherein the resilient seal comprises a teflon seal.

17. A method for sealing a bolt hole formed in a part, wherein a straight shank bolt having a threaded shaft extends from the bolt hole, the method comprising:
positioning a collar on the straight shank bolt, the collar comprising:
a body having a first end and a second end opposite the first end;
an interior threaded portion formed within the body;
a seal cavity formed within the body, the seal cavity positioned adjacent to the interior threaded portion, between the interior threaded portion and the second end; and
a resilient seal positioned within the seal cavity; and
fastening the interior threaded portion of the collar onto the threaded shaft of the straight shank bolt such that the second end of the collar is positioned adjacent to the part and surrounding the bolt hole, and wherein the resilient seal deforms under pressure to form a seal around a circumference of the straight shank bolt.

18. The method of claim 17, wherein fastening the interior threaded portion of the collar onto the threaded shaft of the straight shank bolt comprises deforming the resilient seal to substantially fill the seal cavity.

19. The method of claim 17, wherein the interior threaded portion comprises a first diameter, wherein the collar further comprises a torque-transmitting shaft having a frangible region positioned between the interior threaded portion and the first end, the frangible region having an inner surface comprising a second diameter that is greater than the first diameter, and wherein fastening the interior threaded portion of the collar onto the threaded shaft of the straight shank bolt comprises fastening until the torque-transmitting shaft shears apart from the collar.

20. The method of claim 17, wherein the bolt hole comprises a countersunk surface, and wherein fastening the interior threaded portion of the collar onto the threaded shaft of the straight shank bolt comprises deforming the resilient seal to seal the countersunk surface of the bolt hole.
